(19) United States
(12) Patent Application Publication
(10) Pub. No.: US 2012/0301073 A1
(43) Pub. Date: Nov. 29, 2012

(54) INTEGRATED SILICON PHOTONIC ACTIVE OPTICAL CABLE COMPONENTS, SUB-ASSEMBLIES AND ASSEMBLIES

(76) Inventors: Jeffery A. DeMeritt, Painted Post, NY (US); Richard R. Grzybowski, Corning, NY (US); Klaus Hartkorn, Painted Post, NY (US); Brewster R. Hemenway, JR., Painted Post, NY (US); Micah Colen Isenhour, Lincolnton, NC (US); Christopher Paul Lewallen, Hudson, NC (US); James Phillip Luther, Hickory, NC (US); James S. Sutherland, Corning, NY (US)

(21) Appl. No.: 13/439,912

(22) Filed: Apr. 5, 2012

Related U.S. Application Data
(63) Continuation of application No. PCT/US10/51416, filed on Oct. 5, 2010.
(60) Provisional application No. 61/250,272, filed on Oct. 9, 2009.

(51) Int. Cl. G02B 6/38; G02B 6/12

(52) U.S. Cl. 385/14; 385/59

(57) ABSTRACT

Integrated silicon photonic active optical cable assemblies (ACOAs), as well as sub-assemblies and components for AOCAs, are disclosed. One component is a multifiber ferrule configured to support multiple optical fibers in a planar array. The multifiber ferrule is combined with a flat top to form a ferrule sub-assembly. Embodiments of a unitary fiber guide member that combines the features of the multifiber ferrule and the flat top is also disclosed. The ferrule sub-assembly or the fiber guide member is combined with a photonic light circuit (PLC) silicon substrate with transmitter and receiver units to form a PLC assembly. The PLC assembly is combined with a printed circuit board and an electrical connector to form an ACOA. An extendable cable assembly that utilizes at least one ACOA is also described.

### PRIORITY APPLICATION

This application is a continuation of International Application No. PCT/US10/51416, filed Oct. 5, 2010, which claims the benefit of priority to U.S. App. No. 61/250,272, filed Oct. 9, 2009, both applications being incorporated herein by reference.

### FIELD

The present disclosure relates to optical fiber connector components and assemblies, and in particular to active optical cable components, sub-assemblies and assemblies that employ integrated silicon photonic structures.

### BACKGROUND ART

Certain types of optical fiber connector assemblies are active systems referred in the art as “active optical cable assemblies” or AOCAs. AOCAs optically connect optical fibers carried by an optical fiber cable to active optoelectronic elements, such as a transceiver (e.g., transmitter and receiver devices or electro-optical converters), within the AOCAs. The AOCAs typically employ electrical connectors configured to connect with electrical devices or electrical cables. AOCAs are used to interconnect devices such as computers, servers, routers, mass-storage devices, computer chips and like data devices, and are often used in telecommunication networks.

The optical fibers in ACOAs must be precisely and securely aligned with integrated optical waveguides and/or the optoelectronic elements therein, or the light signals propagating through the assembly will be severely degraded by attenuation and other optical losses.

In addition to providing precise optical alignment, ACOAs need to handle multiple fibers in a cost-effective manner. This often means forming ACOAs with as few parts as possible, and also using as few processing steps as possible. For example, in the case where ACOAs employ planar light circuits (PLCs) formed in silicon substrates, it is desirable to minimize etch steps used to form the channel waveguides. In addition, it is desirable to be able to package the ACOAs in as straightforward a manner as possible, which requires novel ACOA components and configurations.

### SUMMARY

The present disclosure is directed to integrated silicon photonic active optical cable assemblies (ACOAs), as well as sub-assemblies and components for AOCAs. One component is a multifiber ferrule configured to support multiple optical fibers in a planar array. The multifiber ferrule is combined with a flat top to form a ferrule sub-assembly. Embodiments of a unitary fiber guide member that combines the features of the multifiber ferrule and the flat top is also disclosed. The ferrule sub-assembly or the fiber guide member is combined with a photonic light circuit (PLC) silicon substrate with transmitter and receiver units to form a PLC assembly. The PLC assembly is combined with a printed circuit board and an electrical connector to form an ACOA. Laser processing of optical fibers uses in the PLC assemblies and in the ACOAs is also disclosed.

These and other advantages of the disclosure will be further understood and appreciated by those skilled in the art by reference to the following written specification, claims and appended drawings.

### BRIEF DESCRIPTION OF THE DRAWINGS

A more complete understanding of the present disclosure may be had by reference to the following detailed description when taken in conjunction with the accompanying drawings wherein:

FIG. 1 is a perspective view of an example embodiment of a multifiber alignment ferrule;

FIG. 2 is a cross-section of the multifiber ferrule of FIG. 1 as taken along the line 2-2 therein;

FIG. 3 is perspective view of the multifiber ferrule of FIG. 1 shown supporting an array of optical fibers;

FIG. 4 is a perspective bottom-up view and FIG. 5 is perspective top-down view of a sub-assembly formed by the multifiber ferrule and a flat top cover;

FIG. 6 is a perspective view of a silicon substrate having a plurality of grooves formed in the upper surface and sized to accommodate the bare optical fiber sections shown in the sub-assembly of FIG. 4;

FIG. 7 is a top-down schematic diagram of the channel waveguide array of the silicon substrate and shows an electrical-to-optical (E/O) transmitter unit and an optical-to-electrical (O/E) receiver unit residing in respective transmitter and receiver support features;

FIG. 8 is a schematic diagram similar to FIG. 7 and illustrates an example embodiment wherein the receiver unit has detector elements and wherein bare fiber sections extend directly to the detector elements, thereby obviating the need for a channel waveguide array for the receiver unit;

FIG. 9 and FIG. 10 are top-down and bottom-up perspectives views and FIG. 11 is a side view of the assembly formed by the sub-assembly of FIG. 4 and FIG. 5 and the silicon substrate of FIG. 6;

FIG. 12 is a close-up view of the fiber ends in the PLC assembly illustrating an example embodiment where the fibers have multiple cores and the channel waveguide array has corresponding channel waveguides;

FIG. 13 is a close-up view similar to that of FIG. 12 and illustrates an example embodiment wherein fiber ends have a concave shape to facilitate optical coupling with the channel waveguides of the silicon substrate;

FIG. 14 is a top-down perspective view of an example PLC assembly wherein the cover and ferrule are combined into a single guide member that is interfaced with the silicon substrate;

FIG. 15 is a close-up, top-down perspective view of a portion of the receiver unit showing the elliptical detector elements and angled optical fiber ends residing thereon;

FIG. 16 is a close-up side view of the elliptical detector elements and the optical fiber ends shown in FIG. 15;

FIG. 17, FIG. 18 and FIG. 19 are different perspective views of an example PLC assembly guide member;

FIG. 20 is a top-down perspective view of the PLC assembly of FIG. 17, FIG. 18 and FIG. 19, and shows transmit and receive fibers feeding into an integrated crimp body;

FIG. 21 is a perspective view of an example AOCA that includes an example PLC assembly;

FIG. 22 is a top-down view of the AOCA of FIG. 20;

FIG. 23 is a close-up, top-down view of the receiver unit of the AOCA of FIG. 21 and FIG. 22 showing the array of fibers residing atop the staggered detector elements;

FIG. 24 is a close-up side view of the receiver unit of FIG. 23, showing how the optical fibers are slightly flexed to provide a contacting force between the fiber ends and the detector elements;

FIG. 25 is a close-up view of guide member of the guide member of the AOCA of FIG. 21, showing the guide member back end in contact with the alignment structure;

FIG. 26 is a bottom-up perspective view of guide member the showing grooves formed therein as well as the window used for in situ processing of the fibers;

FIG. 27 is a perspective view of an example extendable AOCA cable assembly 502 that utilizes two AOCAs;

FIG. 28 is a close-up view of one of the extendable AOCA devices; and

FIG. 29 is similar to FIG. 28 and shows the second fiber optic cable and AOCA extracted from the AOCA device and connected to a target device, while the AOCA device is attached to an equipment rack that supports the target device;

FIG. 30 is a perspective view of an example PLC assembly wherein discrete transmit and receive fibers are held within a monolithic fiber guide member;

FIG. 31 is a perspective view of an example embodiment of a PLC assembly wherein transmit and receive fibers are end-coupled to the silicon waveguides and so have the same laser processing of the fiber ends;

FIG. 32 is an exploded view of the example PLC assembly FIG. 30, illustrating how the alignment features are used to keep the fiber guide member and the silicon substrate aligned;

FIG. 33 is similar to FIG. 30, and shows an example embodiment wherein the fiber guide comprises two separate sections that respectively guide the transmit and receive fibers;

FIG. 34 is a perspective view of an example fiber guide member configured to interleave the transmit and receive fibers so that the ends of these fibers lie along the same line;

FIG. 35 is similar to FIG. 33, and shows an example PLC assembly that further includes respective fiber organizers for the transmit and receive fibers;

FIG. 36 is a perspective view of an example PLC assembly having a unitary guide member interfaced with a silicon substrate, and showing an example fiber organizer at the input end of the guide member;

FIG. 37 is a schematic diagram similar to FIG. 35 and illustrates an example embodiment of a fiber organizer that takes fibers having no particular configuration and arranging them into a select configuration;

FIG. 38 is a perspective view of a PLC assembly arranged in a hinged fiber-handling housing; and

FIG. 39 is a perspective view of an example laser processing station used to laser process transmit and/or receive fibers when these fibers are arranged with the PLC assembly.

### DETAILED DESCRIPTION

Reference is now made in detail to the present preferred embodiments of the disclosure, exemplary embodiments of which are illustrated in the accompanying drawings. Whenever possible, the same or like reference numbers and symbols are used throughout the drawings to refer to the same or like parts.

In the discussion below, an AOCA or “AOCA device” is defined generally herein as a connector device that connects a fiber optical cable to an electronic device, and that converts optical signals from the optical fiber to electrical signals for processing by the electronic device, and electrical signals from the electronic device to optical signals to be carried by the optical fiber.

### Multifiber Ferrule

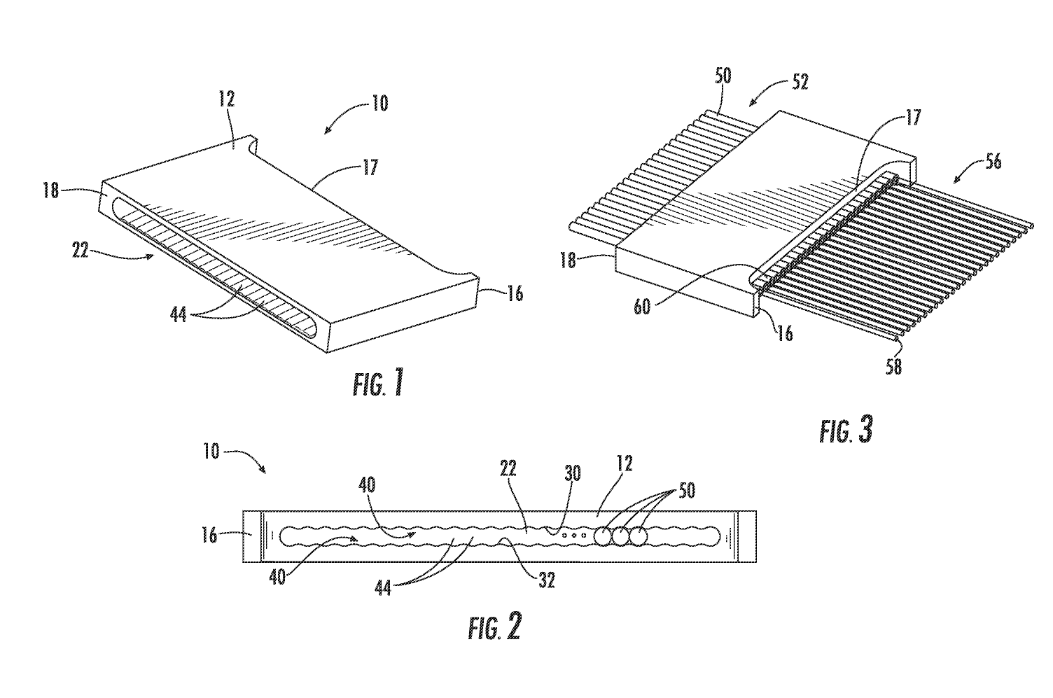

FIG. 1 is a perspective view of an example embodiment of a multifiber alignment ferrule (“multifiber ferrule”) 10. FIG. 2 is a cross-section of multifiber ferrule 10 of FIG. 1 as taken along the line 2-2. Multifiber ferrule 10 includes a generally rectangular and planar unitary ferrule body 12 having an upper surface 14, a front end 16, a back end 18 and an elongate central opening 22 that extends from the front end to the back end. Central opening 22 is defined in part by upper and lower walls 30 and 32 that include opposing rounded grooves 40 that define slots 44 each sized to accommodate an optical fiber 50. In an example embodiment, multifiber ferrule 10 is a molded part, e.g., molded plastic. In an example embodiment, multifiber ferrule 10 is used as a component in a planar light circuit (PLC) assembly and an AOCA assembly, as described in greater detail below.

FIG. 3 is perspective view of multifiber ferrule 10 shown supporting an array 52 of optical fibers 50. The planar nature of multifiber ferrule 10 serves to supports fibers 50 in a ribbonized fiber array 52. In an example embodiment, fiber array 52 is formed from loose fibers, such 250 μm coated fibers. In an example embodiment, fibers 50 are secured within multifiber ferrule 10 using, for example, a bonding material such an epoxy or an adhesive. Fibers 50 include respective bare fiber sections 56 having respective ends 58, and coated fiber sections 60. In an example embodiment, bare fiber sections 56 are about 4 mm long.

In an example embodiment, ferrule body front end 16 includes a cut-out 17 configured to facilitate in situ laser processing of fibers 50 supported therein, e.g., it allows for laser polishing, laser cleaving and/or laser stripping of the fibers. Laser cleaving and/or laser polishing is performed in one example so that fiber ends 58 are substantially coplanar (i.e., the fiber endfaces falling into a common plane). Fiber ends 58 may have an angle other than 90° relative to the fiber axis, e.g., in order to suppress reflections. In one example, laser processing of fibers 50 is performed by arranging the fibers in multifiber ferrule 10 at a first position, laser processing the fibers, and then arranging the fibers in the multifiber ferrule at a second position. In an example embodiment, laser processing of fibers 50 supported by multifiber ferrule 10 is accomplished by placing the multifiber ferrule and fibers into a fixture of a laser processing apparatus.

In an example embodiment, the laser processing of fibers 50 include laser polishing to achieve “coplanarity”, or the state of all the fiber ends 58 falling into a common plane, and minimal angle variation between the fiber ends. In an example embodiment, putting an angle on the fiber ends 58 is desirable for reflection suppression.

### Ferrule Sub-Assembly

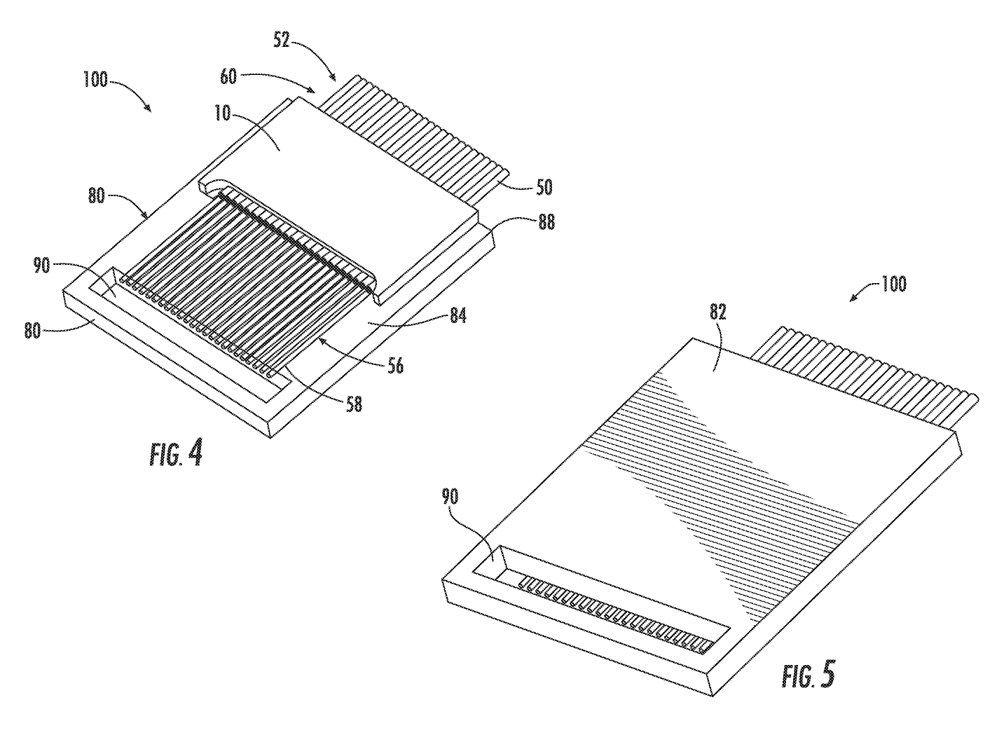

FIG. 4 is a perspective bottom-up view and FIG. 5 is perspective top-down view of a ferrule sub-assembly 100 formed by combining multifiber ferrule 10 with a flat top cover 80. Top cover 80 is planar (i.e., is in the form of a substrate) having an upper surface 82, a lower surface 84, a front end 86, and a back end 88. Top cover 80 includes a window 90 shown as formed near front end 86 and that connects the upper and lower surfaces 82 and 84. Fiber ends 58 extend into window 90, which allows for in situ processing (e.g., laser processing) of fibers 50. In an embodiment where fibers 50 are pre-processed, window 90 can be eliminated. Multifiber ferrule top surface 14 is attached to the top cover bottom surface 84, e.g., via a bonding material such as an adhesive.

### PLC Silicon Substrate

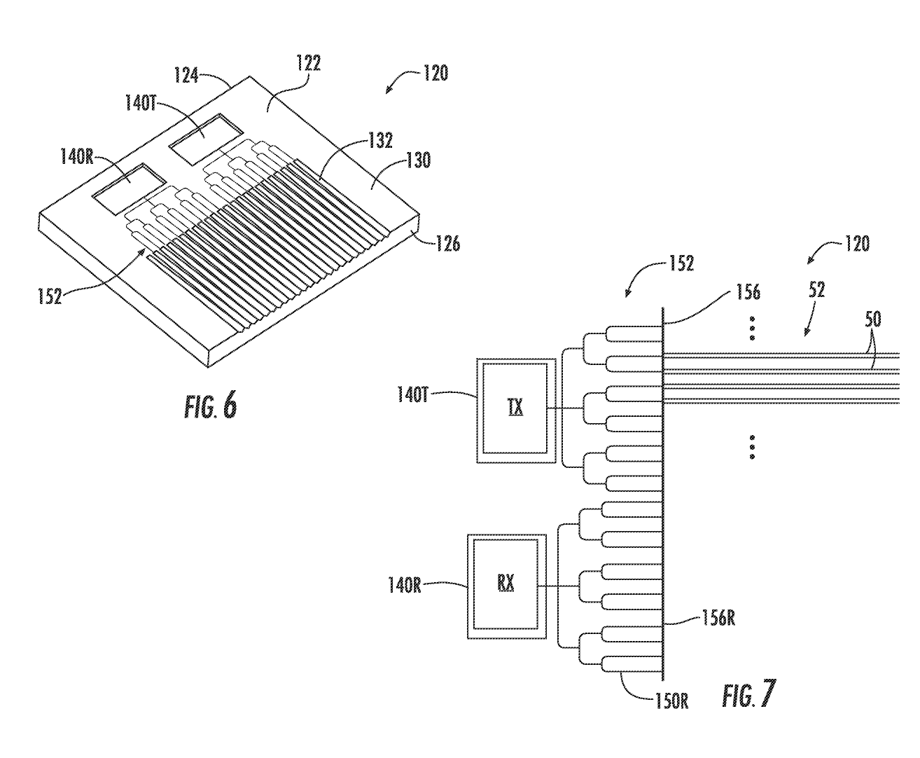

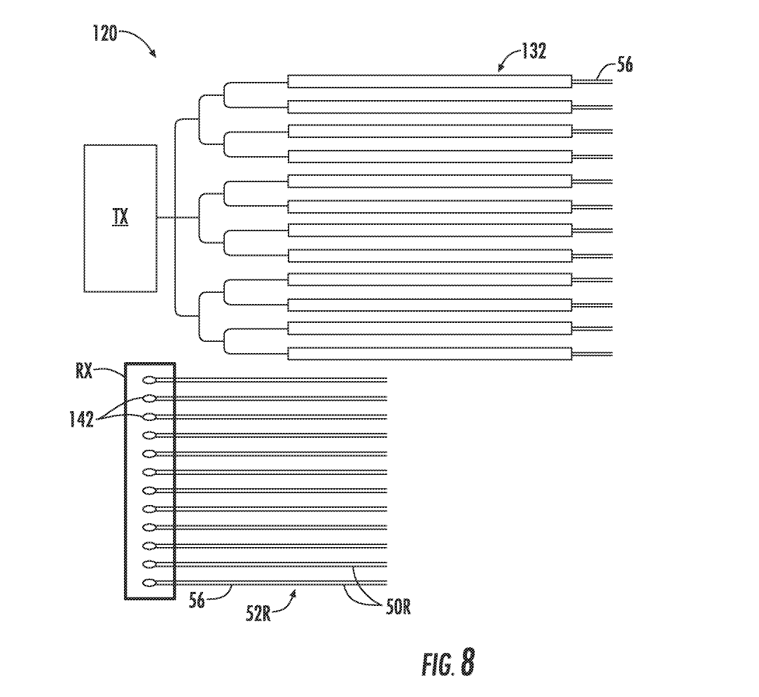

FIG. 6 is a perspective view of a PLC silicon substrate 120 that constitutes an integrated silicon photonic structure to be combined with the sub-assembly 100 discussed above. PLC silicon substrate 120 has a body 122, a front end 124, a back end 126, and an upper surface 130 having a plurality of grooves 132 (e.g., V-grooves) formed therein. Grooves 132 have open ends 134 at back end 126 and closed ends 136 that terminate in body 122, e.g., roughly in the middle between front and back ends 124 and 126. Grooves 132 are sized to accommodate respective fibers 50. PLC silicon substrate 120 also includes electrical-to-optical (E/O) transmitter and optical-to-electrical (O/E) receiver support features (e.g., indents) 140T and 140R configured to respectively support a transmitter unit and a receiver unit, as described below.

PLC silicon substrate 120 also includes an array 152 of channel waveguides 150 formed in substrate body 122 using standard channel-waveguide-forming techniques.

FIG. 7 is a top-down schematic diagram of channel waveguide array 152 and shows an E/O transmitter unit TX and an O/E receiver unit RX residing in respective transmitter and receiver support features 140T and 140R. E/O transmitter unit TX and an O/E receiver unit RX constitute a transceiver unit TRX that performs both E/O and O/E conversion. An example E/O transmitter unit TX includes vertical-cavity surface-emitting lasers (VCSELs), and an example O/E receiver unit RX includes an array of detector elements such as photodiodes or the like, as discussed below. An example of channel waveguide array 152 includes two main branches 152T and 152R associated with respective transmitter and receiver support features 140T and 140R. Channel waveguides 150T in branches 152T and 152R branch out from the corresponding transmitter and receiver support features 140T and 140R. Channel waveguides 150T and 150R have respective ends 156T and 156R that connect to (i.e., terminate at) respective groove ends 136.

FIG. 8 is a schematic diagram similar to FIG. 7 and illustrates an example embodiment of PLC substrate 120 wherein O/E receiver unit RX has detector elements 142 (e.g., PIN photodiodes, etc.) and wherein a bare fiber sections 156 of one group 52R of fibers 50R extend directly to and are optically coupled to the detector elements, thereby obviating the need for channel waveguide array branch 152R.

In an example embodiment, PLC silicon substrate 120 is configured without sharp corners that could damage fibers 50. In one example, the open groove ends 134 at substrate back end 126 are flared and the corners rounded to prevent sharp groove corners from damaging bare fiber section 56 (including fiber end 58). In another example embodiment, the top edges associated with the intersection of back end 126 and upper surface 130 are rounded to further prevent damage and/or chipping of fibers 50, which can also creates unwanted debris.

### PLC Assembly

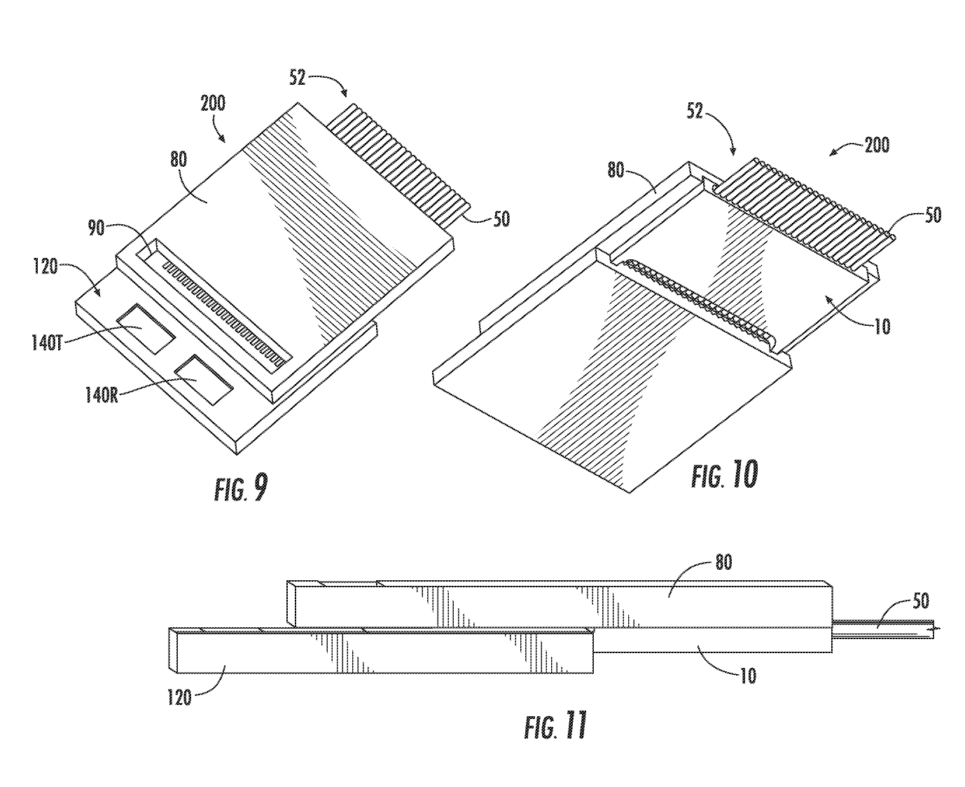

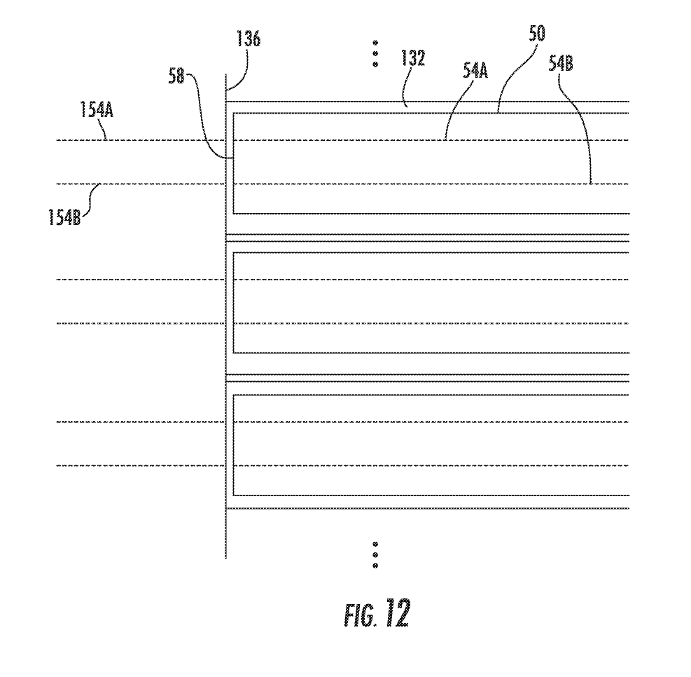

Ferrule sub-assembly 100 is interfaced with PLC silicon substrate 120 to form a PLC assembly 200, as illustrated in the perspective views of FIG. 9 and FIG. 10, and in the side view of FIG. 11. The interfacing is performed such that bare fiber sections 56 of fiber array 52 are seated within respective grooves 132, with fiber ends 58 residing immediately adjacent groove ends 136 and thus optically coupled to channel waveguide ends 156. Ferrule sub-assembly 100 is cantilevered with respect to PLC silicon substrate 120 so that the coated fiber portions 60 of fibers 50 end at silicon body back end 126. This obviates having to etch grooves to support these sections of optical fibers 50. This is advantageous because long etch times are costly and have the potential to compromise the geometry of other features, such as grooves 132.

Once bare fiber sections 56 are properly seated within grooves 132, ferrule sub-assembly 100 is attached to PLC silicon substrate 120 (e.g., top cover lower surface 84 is attached to PLC silicon substrate upper surface 130) using, for example, an ultraviolet-curable epoxy.

In an example of sub-assembly 100, only coated portions 60 of fibers 50 are bonded, while bare fiber sections 56 are free to move prior to interfacing the ferrule sub-assembly 100 and PLC silicon substrate 120 to form PLC assembly 200. This allows for adjustability of bare fiber sections 56 if there are spacing variations in silicon substrate grooves 132. Note also that PLC assembly 200 does not require additional alignment devices for aligning bare fiber sections 56 to channel waveguide ends 156. Variations in the size of substrate grooves 132 and the outside diameters of bare fiber sections 56 can be maintained with require tolerances (e.g., within ±1.0 μm for both fiber and groove) such that the total misalignment tolerance between bare fiber sections 56 and channel waveguides 152 is within the +/−4.0 μm tolerance usually required for single-mode-fiber coupling.

In an example embodiment, grooves 132 are formed using a silicon etch process carried out in a manner that controls groove depth to the above-stated tolerance. In an example embodiment, the groove depth is between about 60 μm to 70 μm, which is sufficient to accommodate single-mode bare fiber sections 56. The distance between channel waveguide ends 156 and bare fiber section ends 58 are controlled in one example by butting the two array ends together. Here, the size of any gap between bare fiber section ends 58 and channel waveguide ends 156 is assumed to be dominated by the cut angle of bare fiber section ends 58, which in one example are “flat” or 90° relative to the fiber central axis. In another example embodiment, any such gaps are minimized by forcing fiber ends 58 against waveguide channel ends 156. A reduced diameter of fiber end 56 or small bare-fiber radius improve the chances of achieving adequate Hertzian contact between fiber ends 58 and channel waveguide ends 156.

If in practice the roughly 6.0 mm of lateral extent is too great, then in an example embodiment a fiber holder is employed that allows the fibers to “pivot” and move as a group to close a small angle. In an example embodiment, the fiber holder is formed from an elastomer. For large scale, “intra” printed circuit board use, it may be desirable to use a mechanical attach structure capable of limited mate/de-mate operation. Any one of several spring-loaded solutions are also applicable.

In an example embodiment of PLC assembly 200, fibers 50 are multi-core fibers. Currently, multi-core fibers generally take the form of round fibers with multiple cores. Future multi-core fibers are anticipated to have other cross-sectional shapes, such as a D-shaped cross-section or have a flat top and bottom for orientation purposes. FIG. 12 is top-down, close-up view of fiber ends 58 in PLC assembly 200 illustrating an example embodiment that utilizes multi-core fibers 50. Grooves 132 contain multi-core fibers 50, with each fiber having two cores 54A and 54B. Cores 54A and 54B at fiber ends 56 are substantially aligned with two corresponding channel waveguide cores 154A and 154B of PLC silicon substrate 120.

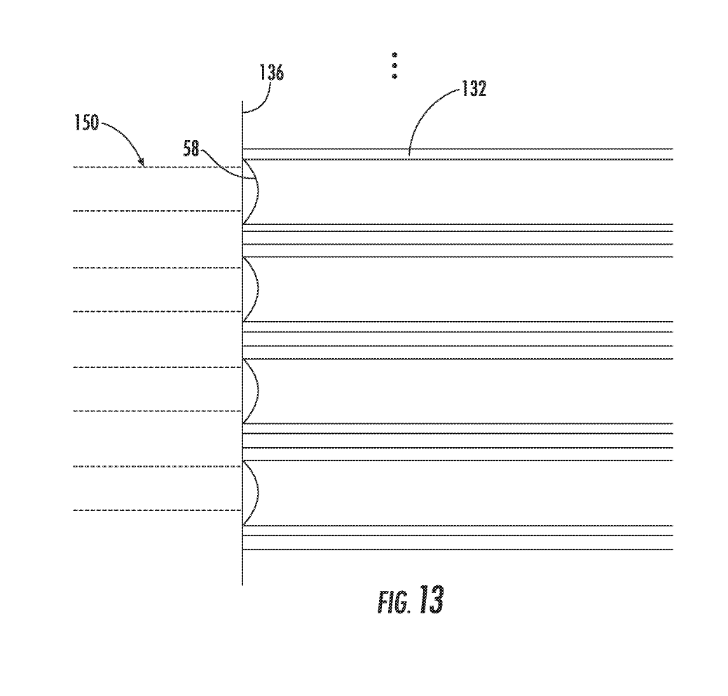

FIG. 13 is a similar view to FIG. 12 and illustrates an example embodiment wherein bare fiber section ends 58 have a concave shape to facilitate optical coupling of the relatively high NA (numerical aperture) light with the corresponding channel waveguides 150 of silicon substrate 120. In an example embodiment, concave fiber ends 58 are formed by laser processing, while in another embodiment they are formed using a wet-etch process.

Another alternative aimed at bolstering the robustness of PLC assembly 200 and improving its ability to resist forces includes adding a “cover layer” over the current clad layer. The cover layer adds mechanical strength through the added thickness and provides resistance to forces generated during butt coupling.

In an example embodiment that yields higher densities and lower chip sizes, 125.0 μm fibers on 250.0 μm centers are “interleaved.” This doubles the density and simplifies the etch detail. An example interleaved configuration is discussed in greater detail below.

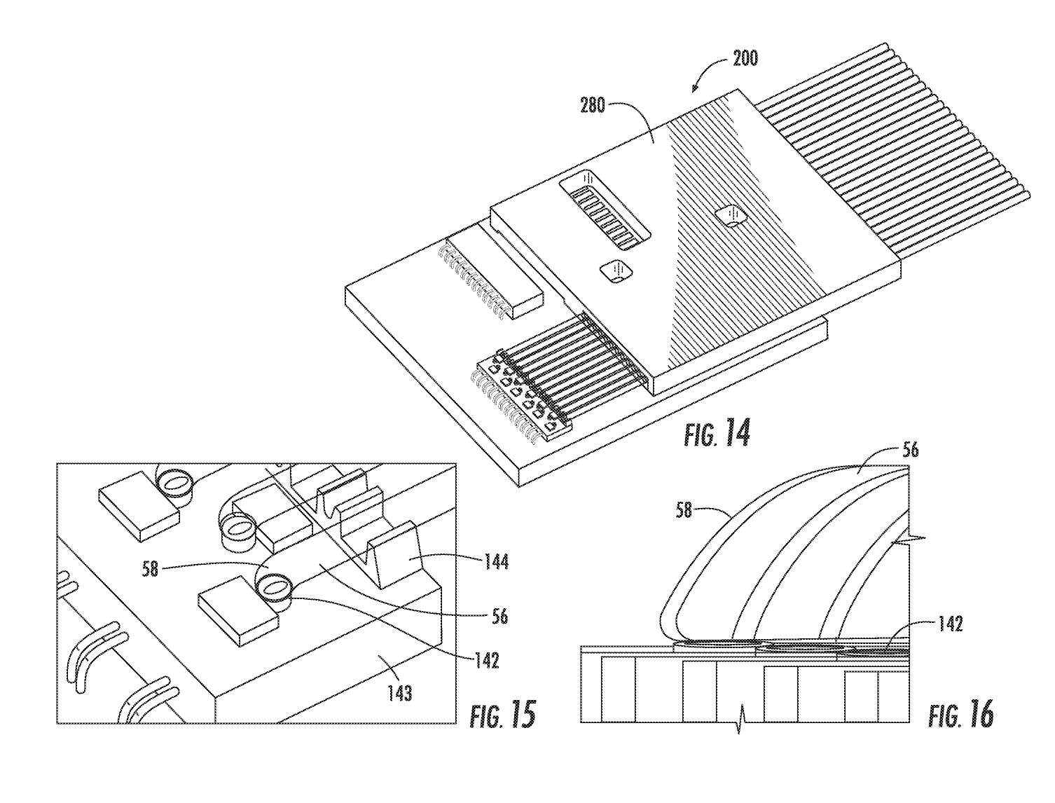

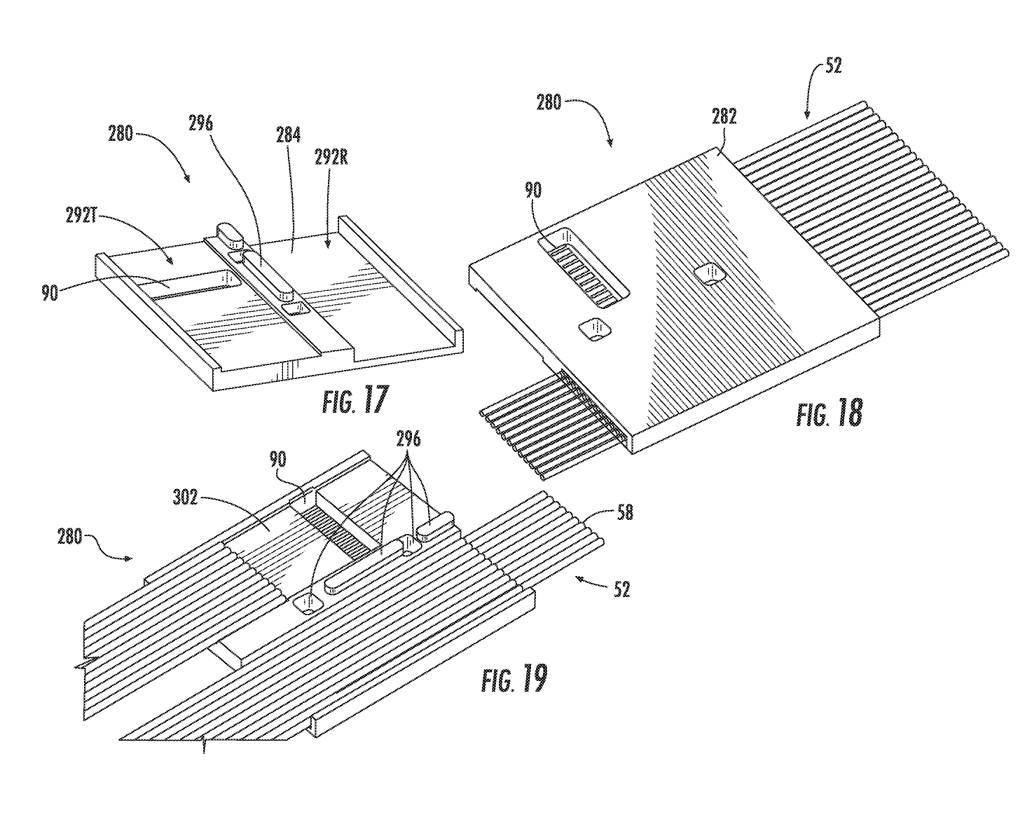

FIG. 14 is a top-down perspective view of an example embodiment of PLC assembly 200 that shows an embodiment where multifiber ferrule 10 and top cover 80 are combined into a single (unitary) fiber guide member 280 suitable for use in the PLC assembly when E/O transmitter unit TX and a O/E receiver unit RX have the configuration shown in FIG. 8. Fiber guide member 280 is discussed in greater detail below. PLC assembly 200 includes transmitter and receiver arrays 52T and 52R of transmit fibers 50T and receive fibers 50R, respectively. Fiber guide member 280 optionally includes processing window 90.

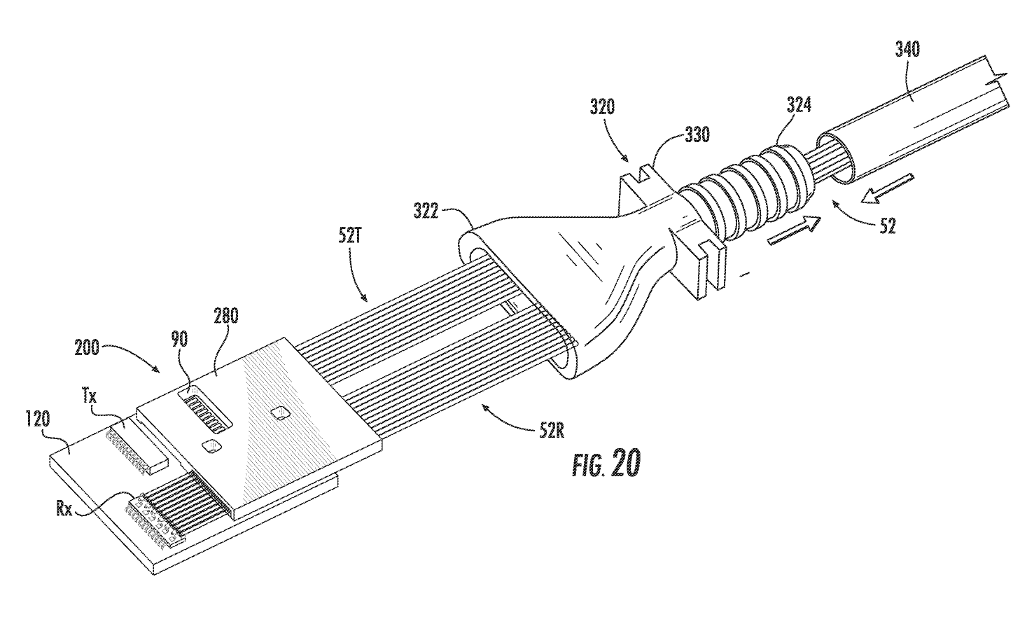

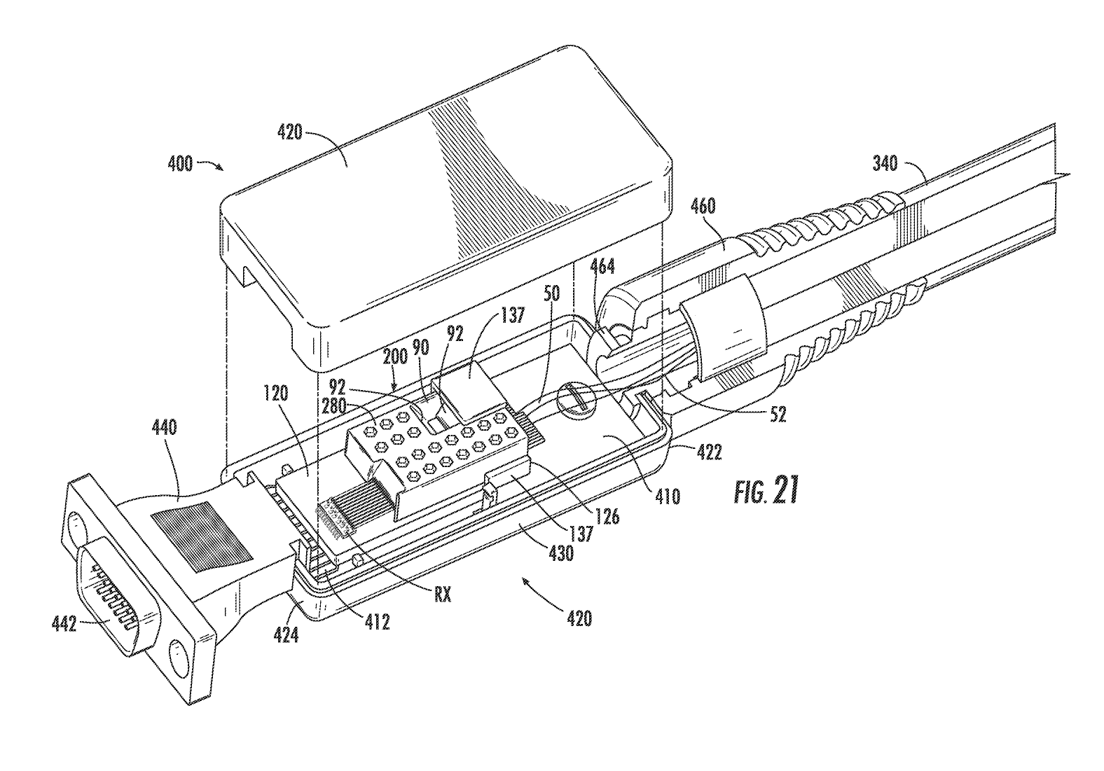

FIG. 15 is a close-up, top-down perspective view of a portion of O/E receiver unit RX and shows detector elements 142 with optical fiber ends 58 residing thereon. O/E receiver unit RX of FIG. 15 has a raised base 143 which in an example embodiment contains or supports detector driver circuitry 145. FIG. 16 is a close-up side view of detector elements 142 and optical fiber ends 58 of receiver fibers 52R. Optical fiber ends 156 of receiver fibers 52R are cut at an angle and rounded off as shown so that light traveling in the fiber is reflected downward to detector elements 142, which preferably have an elliptical shape. Assuming that the core 54 of receiver optical fiber 52R has a circular-cross-section, the light reflected from angle optical fiber end 58 has an elliptical cross-section that substantially matches that of an elliptically shaped detector element 142, thereby making for efficient light detection. In an example embodiment, O/E receiver unit RX includes fiber guides 144 arranged adjacent detector elements 142 and that serve to maintain receiver fibers 52R in place relative to the detector elements. Also in an example embodiment, detector elements 142 are staggered so that O/E receiver unit RX can support a greater number of detector elements.

FIG. 17, FIG. 18 and FIG. 19 are different perspective views of fiber guide member 280, which includes a top side 282, a bottom side 284, a front end 286 and back end 288. Bottom side 284 includes two parallel, open-ended channels 292T and 292R respectively associated with E/O transmitter unit TX and O/E receiver unit RX and thus are referred to as the “transmitter channel” and “receiver channel,” respectively. One or more alignment or keying features 296 are optionally included in between transmit and receive channels 292T and 292R, wherein the keying features mate with corresponding keying features (not shown) on PLC silicon substrate 120. Fiber guide member 280 also optionally includes a window 90 that connects top and bottom sides 282 and 284 at transmitter channel 292T. Window 90 is configured to allow for in situ processing of transmitter fibers 50T when held within transmitter channel 292T. Example processing includes laser processing or chemical processing, such as hot-nitrogen stripping used to remove the coatings from optical fibers.

FIG. 18 and FIG. 19 show arrays 52T and 52R of transmit fibers 50T and receive fibers 50R, respectively, within respective transmitter and receiver channels 292T and 292R. In an example embodiment, receiver channel 292T includes a gripping feature 302, such as an elastomeric layer, arranged adjacent window 90 and that serves to grip bare fiber sections 56 adjacent to coated fiber sections 60 (see FIG. 19). In an example embodiment, transmitter channel 292T has a shallower depth than receive channel 292R because receive fibers 50R have their coated section 60 within receiver channel 292R, while transmit fibers 50T have mostly their bare fiber sections 56 within transmitter channel 292T.

FIG. 20 is a top-down perspective view of PLC assembly 200 of FIG. 13 and shows transmitter and receiver fiber arrays 52T and 52R feeding into a boot member 320, which in an example embodiment is an integrated crimp body. Boot member 320 includes an elongate-shaped (e.g., oval-shaped or rectangular-shaped) output end 322 into which fibers 50 leave the boot member in ribbon form, and a round input end 324 where fibers 50 enter the boot member, e.g., in non-ribbon form. Boot member 320 facilitates fiber management, including transitioning fibers 50 from a wound or otherwise non-planar (non-ribbon) configuration of a (non-ribbon) fiber optic cable 350 to the planar configuration (e.g., ribbon-type arrangement) within PLC assembly 200. In an example embodiment, boot member 320 includes a clip feature 330 between the input and output ends that allows for the boot member to clip to or otherwise be attached to a support structure 370, such as a portion of an equipment rack.

### AOCA

FIG. 21 is a perspective diagram of an AOCA 400 that includes an example PLC assembly 200 attached to a printed circuit board (PCB) 410 that includes wiring 414. FIG. 22 is a top-down view of the AOCA of FIG. 21. PCB 410 resides in a housing 420 having a front end 422 and a back end 424 that includes an opening 426 sized to accommodate an optical fiber cable 340. In an example embodiment, housing 420 includes a lower section 430 and a mating upper section 443. AOCA 400 also includes an electrical connector end 440 operably arranged at housing front end 422 and having electrical contacts 442 that are electrically connected to PCB wiring 414. Electrical connector end 440 may be, for example, an MTP or other like type of multi-pin connector. Optical fiber cable 340 is shown connected to housing back end 424. A flexible boot 460 surrounds fiber cable 340 at housing back end 424, and a cylindrical clip 464 that fits within the boot and within housing opening 426 secures the fiber cable to the housing back end.

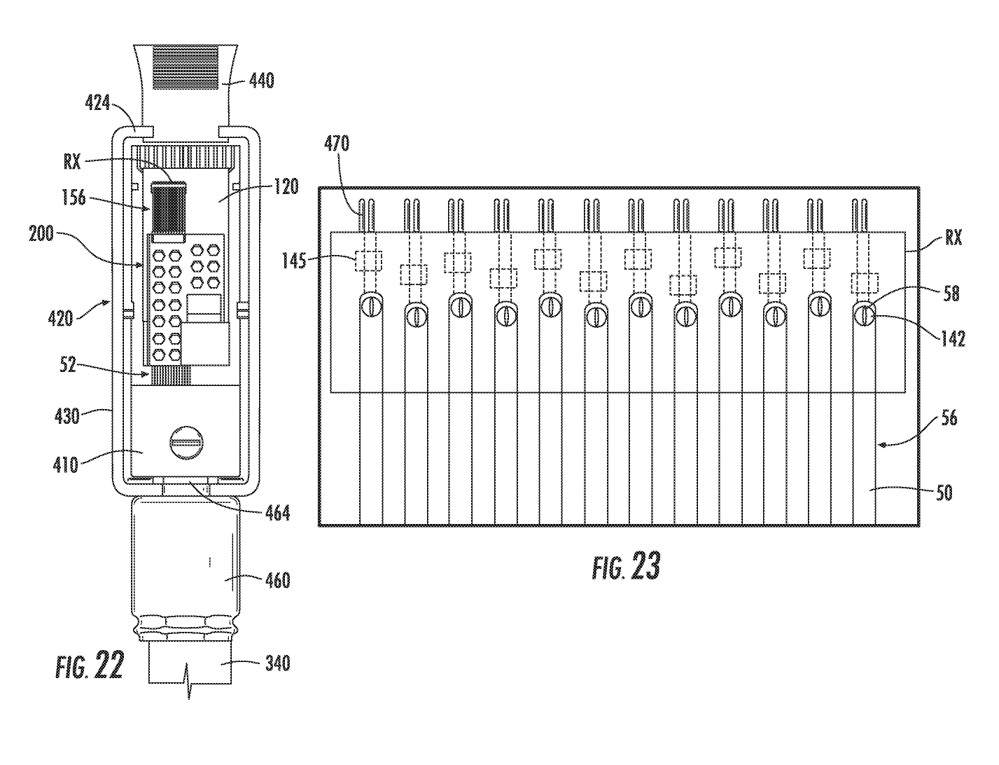

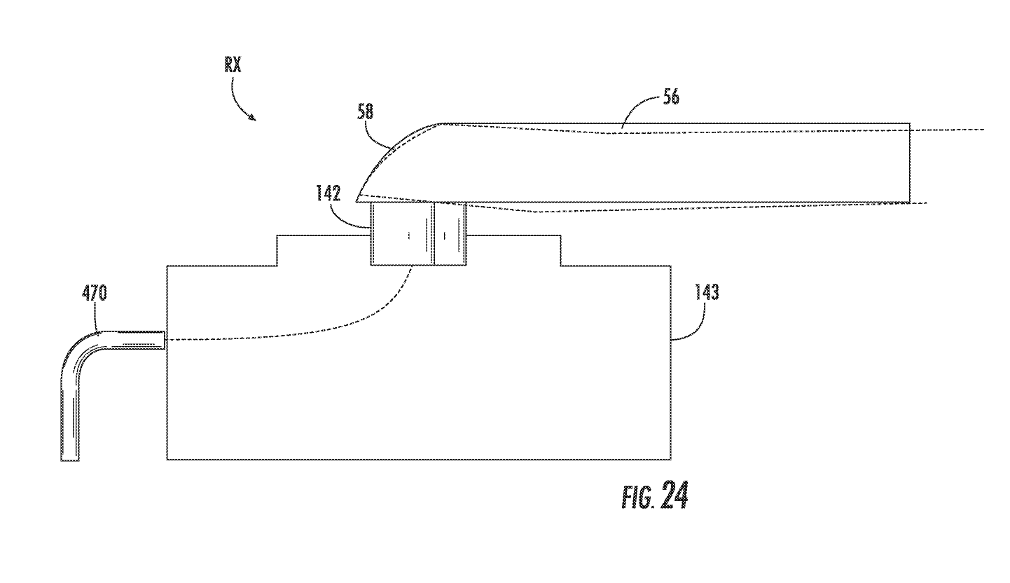

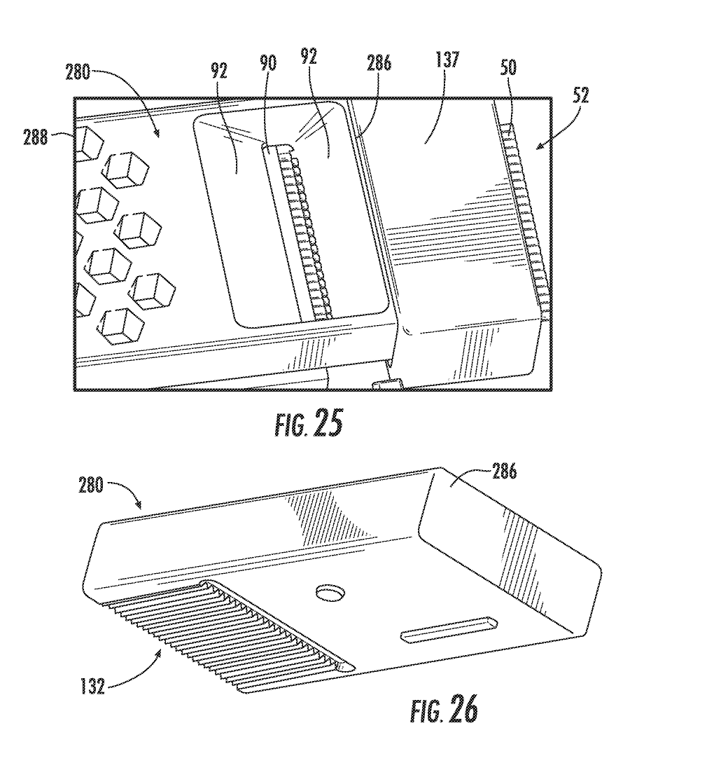

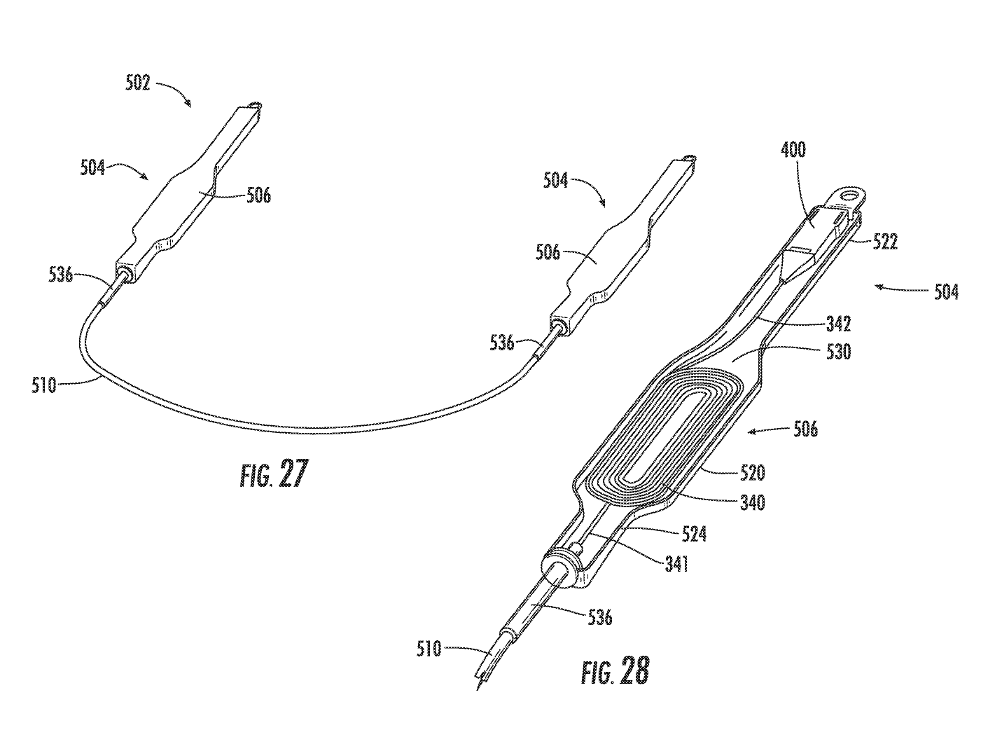

FIG. 23 is a top-down close-up view of O/E receiver unit RX and shows bare fiber section end 58 in contact with detector elements 142. In addition, FIG. 23 illustrates the example embodiment wherein detector elements 142 are staggered. Electrical wiring 470 connects detector elements 142 to PCB wiring 414 and thus to electrical connector end 440.

FIG. 24 is a close-up side view of O/E receiver unit RX and shows an angled fiber end 58 atop detector element 142, and illustrates an example embodiment wherein bare fiber section 56 is slightly flexed to provide a contacting force between the fiber end and the detector element. This serves to preserve contact and alignment between fiber end 58 and detector element 142. In an example embodiment, this configuration is achieved by selecting the height of raised base 143 that applies a select amount of downward force for the given fibers 50.

The PLC assembly 200 used in ACOA 400 of FIG. 21 is similar to that shown in FIG. 14. However, fiber guide member 280 as shown in FIG. 21 is slightly modified to accommodate a raised alignment structure 137 disposed at the back end 126 of PLC silicon substrate 120. Alignment structure 137 is configured to help maintain fiber guide member 280 aligned relative to silicon substrate 120 by the guide member back end 286 contacting the alignment structure when the guide member is properly positioned relative to PLC silicon substrate 120. Window 90 in guide member 280 is shown located adjacent back end 286. Window 90 includes at least one sloped face 92 to facilitate laser processing of fibers 50 through the window at a variety of angles relative to normal incidence.

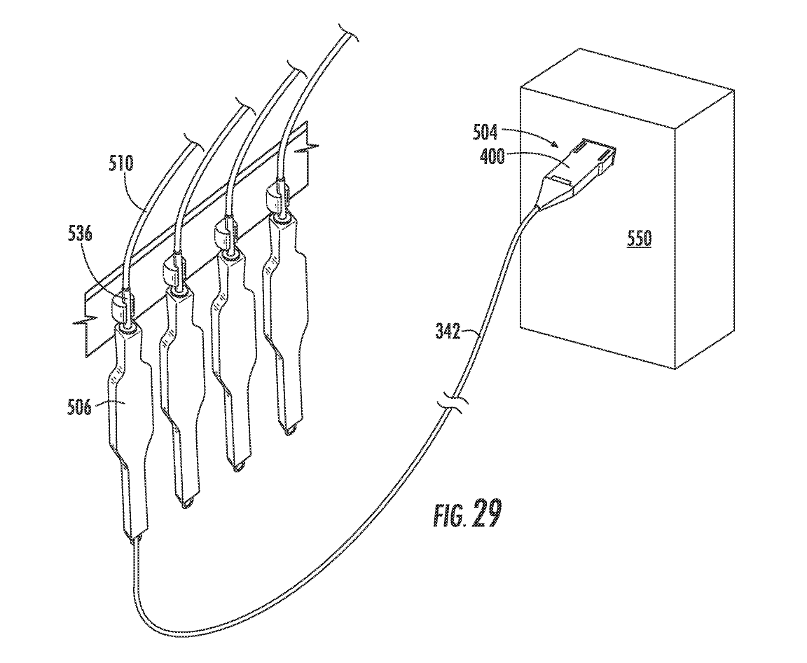

FIG. 25 is a close-up view of fiber guide member 280 and window 90 therein, and shows the guide member back end 286 in contact with alignment structure 137. Hexagonal holes 288 in guide member top side 282 arise in an example embodiment where guide member 280 is formed by a mold process, and help reduce the weight of the guide member.

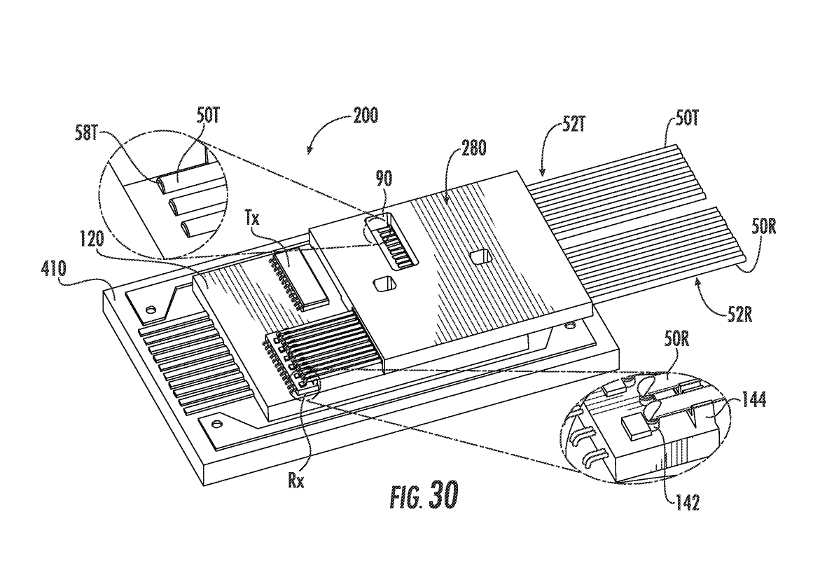

FIG. 26 is a bottom-up perspective view of fiber guide member 280 showing grooves 132 formed in bottom side 284. The fiber guide member 280 of FIG. 26 is a monolithic structure wherein its features are designed to require minimal etch times. Example keying features 296 include pin and rib arrangement, wherein the pin diameter fits precisely into a first elongated groove, while the rib width fits precisely into a second elongated groove. The rib sets up the “X” and rotation, while the pin picks up “Y” rotation. The Z-dimension comes off of small longitudinal ribs on the ferrule bottom to minimize the effect of dirt on the coupling accuracy.

In an example embodiment, fiber guide 280 is formed from or otherwise includes material that closely matches the coefficient of thermal expansion of silicon body 120 to prevent large excursions in placement accuracy due to temperature changes. In an example embodiment, fiber guide 280 is formed from silicon.

Extendable Cable Assembly with AOCAs

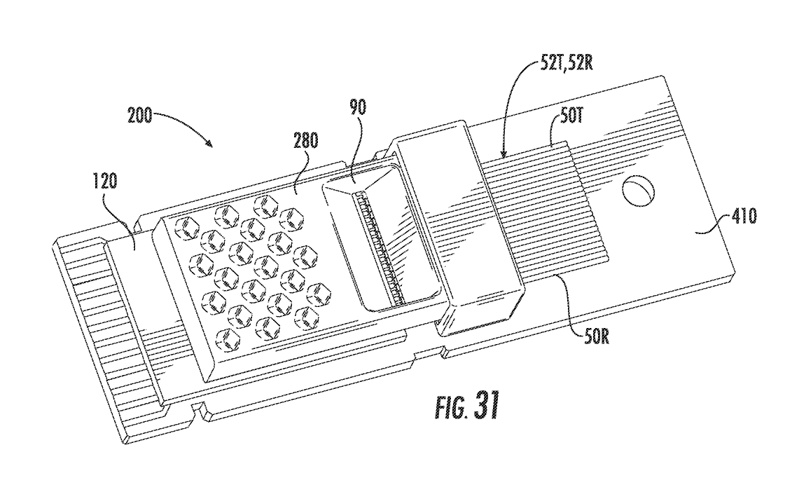

FIG. 27 is a perspective view of an example embodiment of an extendable cable assembly 502 that utilizes two AOCA devices, such as two AOCAs 400 as described above. Extendable cable assembly 502 includes two cable storage devices 504 operably connected by a main fiber optic cable 510.

FIG. 28 is a close-up view of one of cable storage devices 504. Cable storage devices 504 each include an enclosure 506 having an interior 507. Enclosure 506 is relatively flat and in an example embodiment includes a wide, center portion 520 and narrow front end and back end portions 522 and 524. Cable storage device 504 includes fiber optic cable 340 optically connected at an end 341 to main fiber optic cable 510 at housing back end portion 522 via a flange 536. A portion of fiber optic cable 340 is coiled within enclosure interior 507 in center portion 520, while the other end 342 of fiber optic cable 340 is connected to an AOCA 400 movably disposed at enclosure front end portion 522. In an example embodiment, AOCA 400 resides within front end portion 522. In an example embodiment, main fiber optic cable 510 is heavier and more rugged than the first fiber optic cable 340, and has a larger outside diameter. The coiled portion of fiber optic cable 340 is configured to be uncoiled, and in an example embodiment is also configured to be retractable back into enclosure 506.

With reference also to FIG. 29, extendable AOCA cable assembly 502 is deployed between target devices 550 where enclosures 506 are supported by respective flanges 536, which in an example embodiment are configured to anchor to an equipment rack 560. The smaller diameter fiber optic cable 340 and AOCA 400 are then pulled from enclosure interior 507. As the coiled portion of fiber optic cable 340 within enclosure interior 507 uncoils, it and AOCA 400 are then routed by hand to respective target devices 550 within equipment rack 560.

Another example embodiment of extendable AOCA cable assembly 502 includes only one cable storage device 504.

Extendable cable assembly 502 provides advantages relating to heat removal and associated airflow issues at data centers where AOCAs are typically employed. To improve airflow within a data center, it is necessary to reduce the diameter of the fiber optic cables deployed therein. This goal, however, runs counter to the need to make AOCA assemblies as robust as possible. Extendable cable assembly 502 meets both the robustness and airflow goals by providing packaging that provides maximum protection for the AOCA 400 during shipment and installation, yet provides a reduced cable size in the form of fiber optic cable 340 when installed. The extendable nature of assembly also facilitates shipment and deployment.

FIG. 30 is a perspective view of an example PLC assembly 200 wherein discrete transmit and receive fibers 50T and 50R are held within a monolithic fiber guide member 280. In an example embodiment, fiber guide member 280 is a “low accuracy” part, i.e., it need not be manufactured to high tolerances. The end faces of the transmit and receive fibers 50T and 50R are selectively laser processed so that they each respectively interface with the respective transmit and receive devices TX and RX. For example, the receive fiber ends 58R may be formed as tapered as illustrated in FIG. 16, while the transmit fiber ends 58T may be formed as straight edges for butt-coupling into channel waveguides 150 (see FIG. 7). For the receive fibers 50R, fiber guides 144 provide alignment accuracy while the grooves 132 in PLC silicon substrate 120 (see FIG. 6) provide alignment accuracy for transmit fibers 50T. Receiver fibers 50R are preferably long to facilitate positioning. In an example embodiment, the plane in which the receive fiber 50R resides is below that of detectors 142 so that the there is a natural spring force keeping the fiber end 58 in contact with the detector, as shown in FIG. 24.

FIG. 31 is a perspective view of an example embodiment of PLC assembly 200 wherein transmit and receive fibers 50T and 50R each have the same laser processing wherein the fiber ends are edge-coupled to respective transmit and receive waveguides 150T and 150R in PLC silicon substrate 120 (see FIG. 6).

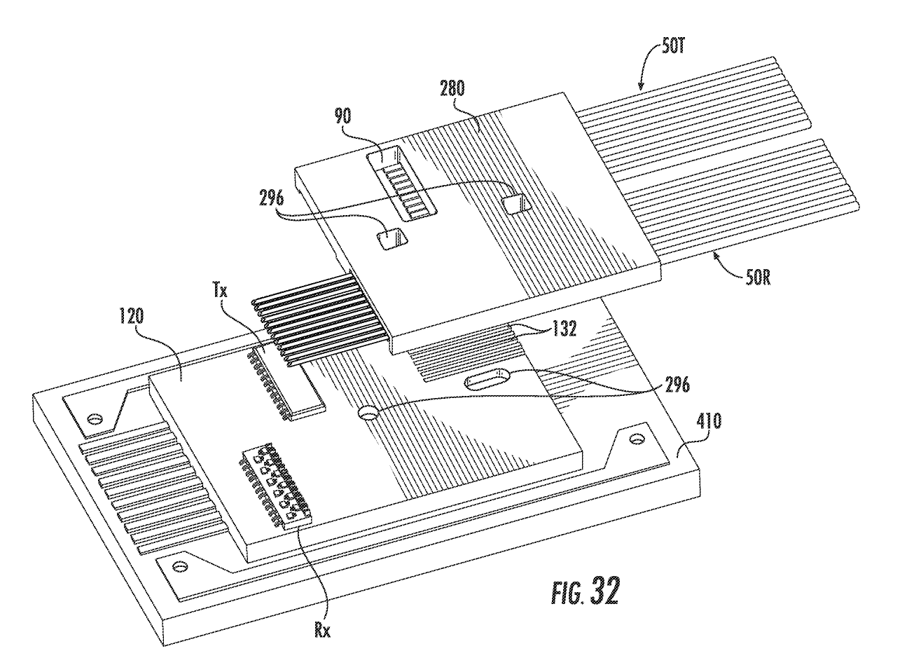

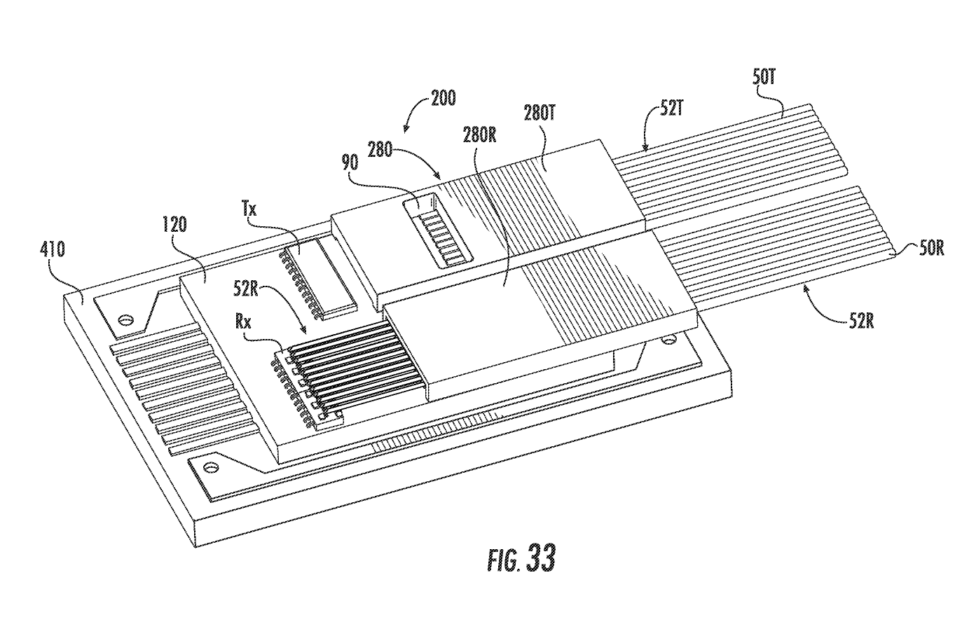

FIG. 32 is an exploded view of the example PLC assembly 200 of FIG. 30, showing how alignment features 296 on fiber guide member 280 and silicon substrate 120 operably engage to align these two structures and keep the PLC assembly together.

FIG. 33 is similar to FIG. 30, and shows an example embodiment wherein fiber guide 280 comprises two separate sections, namely 280T for transmit fibers 50T and 280R for the receive fibers, with section 280T including the optional processing window 90.

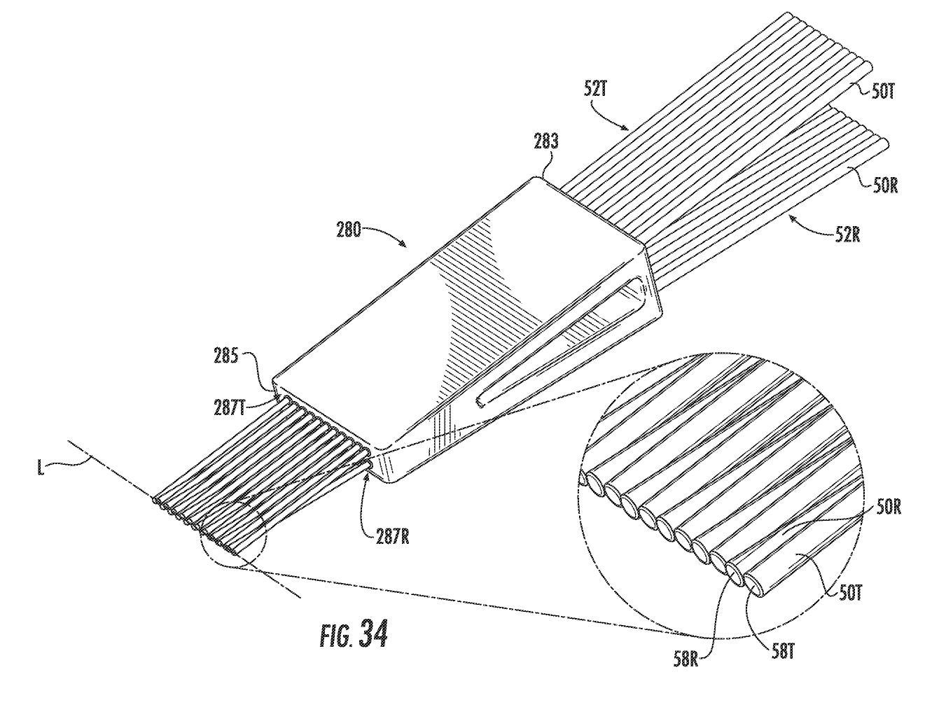

FIG. 34 is a perspective view of an example fiber guide member 280 configured to interleave the transmit and receive fibers 50T and 50R. Fiber guide member 280 has a wedge shape, with a relatively wide input end 283 and a relatively narrow output end 285. Fiber guide member 280 includes two sets of converging grooves 287T and 287R that guide respective transmit fibers 50T and guide fibers 50R. Grooves 287T and 287R converge in a manner that leaves the ends 58T and 58R of transmit and receive fibers 50T and 50R interleaved along a common line L. Thus, fiber guide member 280 is configured to interleave the respective ends 58T and 58R of non-parallel planes of transmit and receive fiber arrays 52T and 52T.

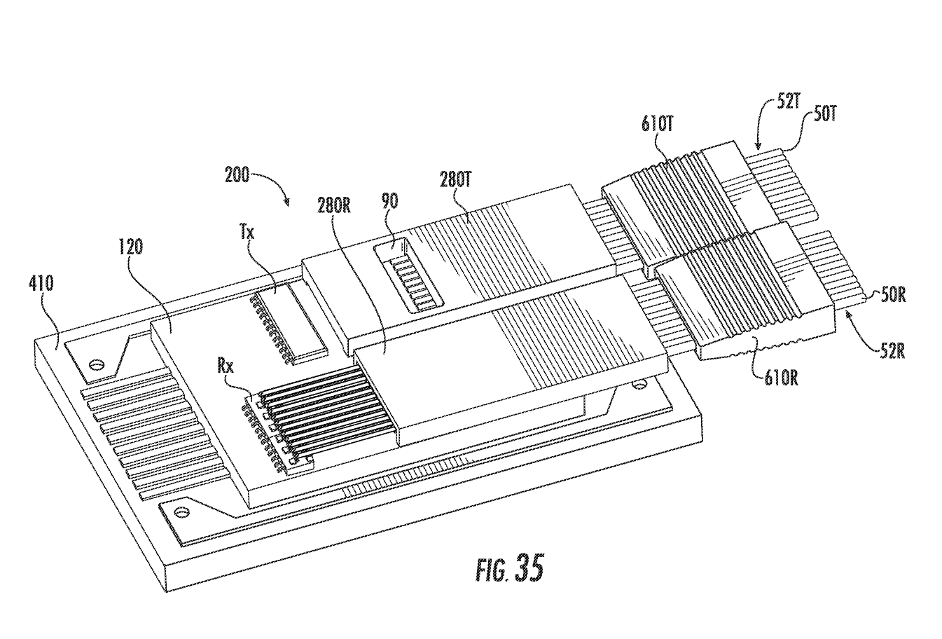

FIG. 35 is similar to FIG. 33, and further includes respective fiber organizers 610T and 610R arranged adjacent respective guide member sections 280T and 280R. Fiber organizers 610T and 610R are configured to organize respective transmit and receive fibers 50T and 50R so that these fibers can be properly held within the respective guide member sections 280T and 280R.

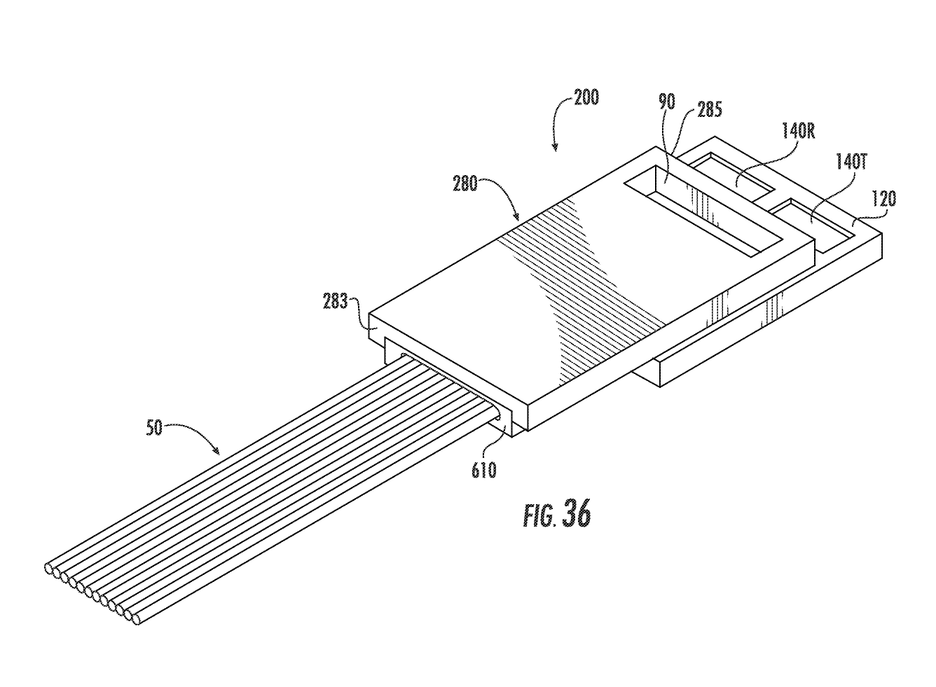

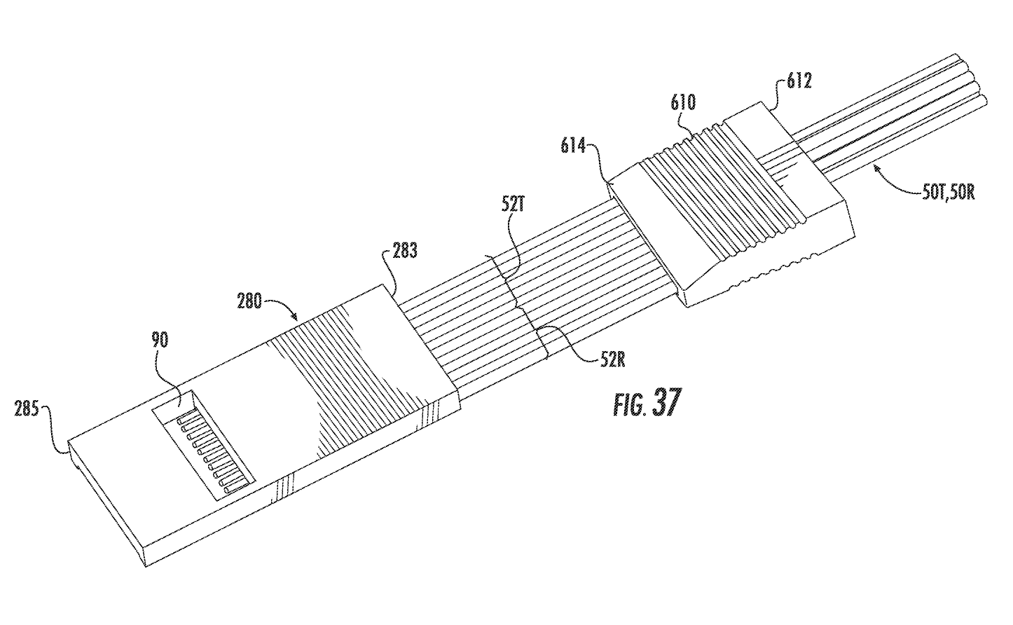

FIG. 36 is a perspective view of an example PLC assembly 200 having a unitary guide member 280 interfaced with silicon substrate 120, and showing an example fiber organizer 610 at the input end 283 of the guide member.

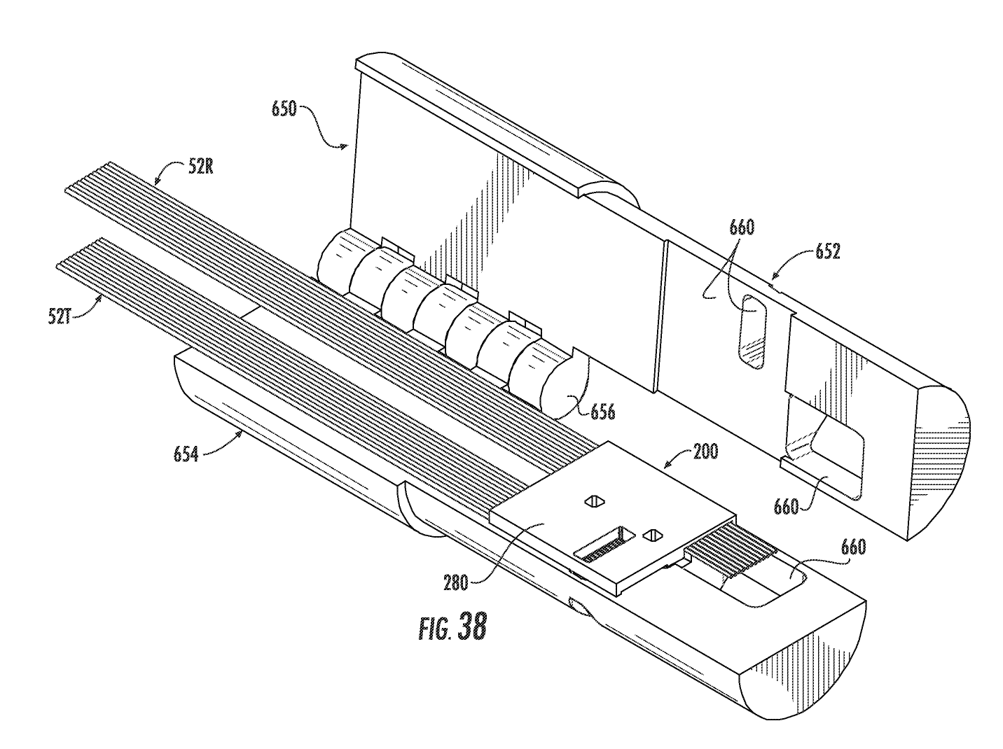

FIG. 37 is a schematic diagram similar to FIG. 35 and illustrates an example embodiment of a fiber organizer 610 configured to receive at an input end 612 a set of transmit and receive fibers 50T and 50R having no particular order or configuration and to output at an output end 614 the transmit and receive fibers in a select order. For example, the outputted fibers 50 are arranged with all of the transmit fibers 50T in one group and all of the receive fibers 50R in another group, rather than having the transmit and receive fiber being intermingled.

FIG. 38 is a perspective view of PLC assembly 200 arranged in a fiber-handling housing 650. In an example embodiment, fiber-handling housing 650 includes an upper section 652 and a lower section 654 joined by a hinge 656. Fiber-handling housing 650 includes internal features 660 (e.g., indents, cavities, etc.) sized to accommodate the various features of PLC assembly 200 when upper and lower sections 652 and 654 are closed around the PLC assembly. In an example embodiment, fiber-handling housing 650 has a cylindrical configuration when closed.

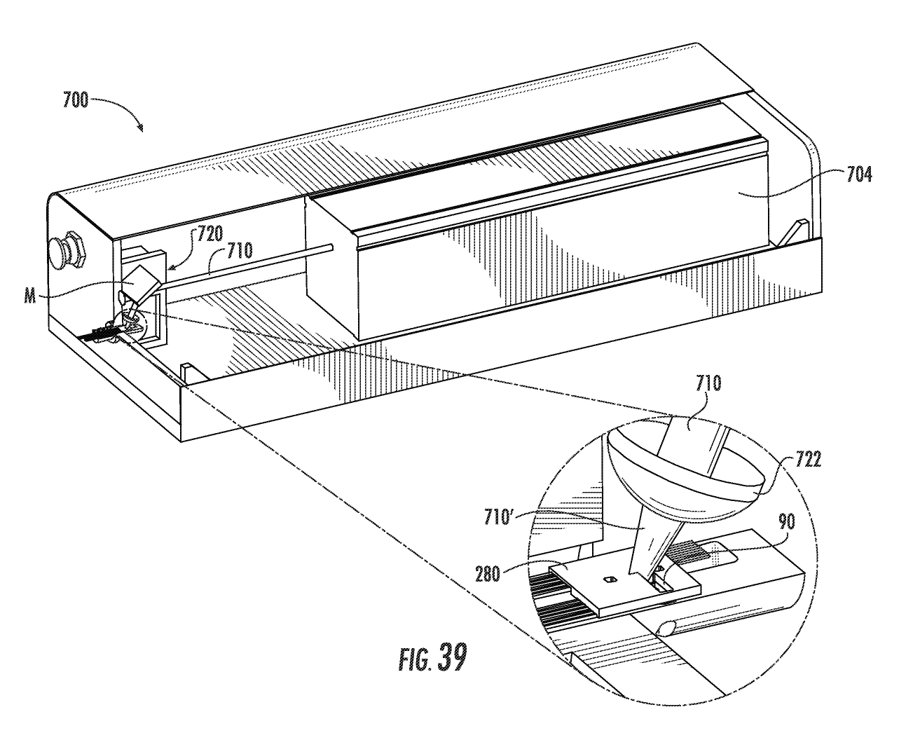

FIG. 39 is a perspective view of an example laser processing station 700 that includes a laser 704 that outputs a laser beam 710. Laser processing station 700 includes an optical system 720 that includes a fold-mirror M and a focusing lens 722 that forms a focused laser beam 710′. As shown in the inset of FIG. 39, PLC assembly 200 is arranged in laser processing station 700 adjacent optical system 720 so that focused laser beam 710′ is directed through laser processing window 90 of fiber guide 280 and to transmit fiber 50T. Focused laser beam 710′ processes transmit fibers 50T. Receiver fibers 50R can also be processed to form, for example, the curved fiber ends 58R such as shown in FIG. 16.

It will be apparent to those skilled in the art that various modifications to the preferred embodiment of the disclosure as described herein can be made without departing from the spirit or scope of the disclosure as defined in the appended claims. Thus, it is intended that the present disclosure covers the modifications and variations of this disclosure provided they come within the scope of the appended claims and the equivalents thereto.

What is claimed is:

1. A ferrule sub-assembly, comprising:
a multifiber ferrule comprising a ferrule body having an upper surface, a front end, a back end, and an elongate central opening that extends from the front end to the back end, wherein the central opening is defined in part by upper and lower walls that include opposing rounded grooves that define slots each sized to accommodate one of the multiple optical fibers; and
a top cover having a lower surface, an upper surface, a front end, and a back end, wherein the multifiber ferrule upper surface is attached to the top cover lower surface, the top cover including a window adjacent the front end and configured to allow for processing of the optical fibers when the optical fibers are supported by the multifiber ferrule and extend into the window.

2. The ferrule sub-assembly of claim 1, wherein the ferrule body is a generally rectangular planar unitary body formed of plastic.

3. The ferrule sub-assembly of claim 2, wherein the ferrule body front end includes a cut-out configured to facilitate laser processing of the multiple fibers when the multiple fibers are supported in the multifiber ferrule.

4. The ferrule sub-assembly of claim 2, wherein the top cover is generally planar.

5. A planar light circuit (PLC) assembly, comprising:
a ferrule sub-assembly comprising:
a multifiber ferrule comprising a generally rectangular unitary ferrule body having an upper surface, a front end, a back end, and an elongate central opening that extends from the front end to the back end, wherein the central opening is defined in part by upper and lower walls that include opposing rounded grooves that define slots each sized to accommodate one of the multiple optical fibers; and a top cover having a lower surface, an upper surface, a front end, and a back end, wherein the multifiber ferrule upper surface is attached to the top cover lower surface, the top cover including a window adjacent the front end and configured to allow for processing of the optical fibers when the optical fibers are supported by the multifiber ferrule and extend into the window;
a PLC silicon substrate comprising:
a silicon body with a front end, a back end, and an upper surface having a plurality of grooves formed therein having open ends at the silicon body back end and closed ends within the silicon body, the grooves being sized to accommodate respective optical fibers;
an array of channel waveguides formed in the silicon body that terminate at at least some of the closed groove ends; and
wherein the silicon body upper surface is attached to the top cover lower surface so that the silicon body back end is adjacent the multifiber ferrule front end.

6. The PLC assembly of claim 5, wherein the PCL silicon substrate includes electrical-to-optical (E/O) transmitter and optical-to-electrical (O/E) receiver support features configured to respectively support a E/O transmitter unit and an O/E receiver unit, and wherein the channel waveguides terminate at one or both of the E/O transmitter and O/E receiver support features.

7. The PLC assembly of claim 6, further including:
E/O transmitter and O/E receiver units respectively operatively supported by the E/O transmitter and O/E receiver support features.

8. The PLC assembly of claim 7, wherein the channel waveguide array includes a transmitter channel waveguide array that terminates at the E/O transmitter unit and a receiver channel waveguide array that terminates at the O/E receiver unit, the PLC assembly further comprising:
the multiple optical fibers, wherein each optical fiber has a bare fiber section with an end, and a coated section, with the coated sections being supported by the multifiber ferrule and the bare fiber sections supported by the grooves, with the bare fiber section ends arranged adjacent the groove ends so that first and second groups of the optical fibers are respectively optically coupled to the E/O transmitter unit and to the O/E the receiver unit via the transmitter channel waveguide array and the receiver channel waveguide array.

9. The PLC assembly of claim 7, wherein the channel waveguide array includes a transmitter channel waveguide array that terminates at the transmitter unit, the assembly further comprising:
the multiple optical fibers, wherein each optical fiber has a bare fiber section with an end, and a coated section, with the coated sections being supported by the multifiber ferrule and the bare fiber sections supported by the grooves, with a first group of the optical fibers having their bare fibers section ends terminating adjacent the groove ends so that they are respectively optically coupled to the E/O transmitter unit via the transmitter channel waveguide array, while a second group of the optical fibers connects directly to the O/E receiver unit.

10. The PLC assembly of claim 5, wherein one or more of the optical fibers have multiple cores, and wherein one or more of the channel waveguides in the array include cores that are configured to optically coupled to the multiple cores when the multiple optical fibers reside in the plurality of grooves.

11. The PLC assembly of claim 5, further including the multiple optical fibers, wherein one or more of the bare fiber section ends are concave to facilitate optical coupling to the corresponding one or more channel waveguides at the groove ends.

12. A planar light circuit (PLC) assembly that connects multiple optical fibers to receiver and transmitter units, comprising:
a unitary fiber guide member having a front and back ends and top and bottom sides, wherein the bottom side has open-ended, parallel transmitter and receiver channels that extend between the front and back ends and are sized to hold respective transmitter and receiver groups of the multiple optical fibers, and having a window that connects the top and bottom sides of the transmitter channel so as to allow for processing of a transmitter group of optical fibers when the transmitter group of fibers is arranged within the transmitter channel; and
a planar light circuit (PLC) silicon substrate having a body with a front end, a back end, and an upper surface attached to the fiber guide member bottom side, the upper surface having a plurality of grooves formed therein that have open ends at the silicon substrate back end and closed ends within the silicon substrate body, the grooves being sized to accommodate the multiple optical fibers, the PLC silicon substrate further having an array of channel waveguides formed therein that terminate at at least some of the closed groove ends.

13. The PLC assembly of claim 12, wherein the transmitter channel includes a gripping feature arranged adjacent the window and configured to grip bare fiber sections of the transmit group of optical fibers.

14. The PLC assembly of claim 12, further including:
E/O transmitter and O/E receiver units operably supported by the silicon substrate, wherein the transmitter group of fibers is optically connected to the E/O transmitter unit via a set of the channel waveguides, and the receiver group of fibers is optically connected directly to respective detector elements of the O/E receiver unit.

15. The PLC assembly of claim 14, wherein the receiver group of fibers include bare fiber sections with angled ends, the detector elements are elliptical in shape, and wherein the angle fiber ends reside atop the elliptical detector elements, and wherein the receiver group of fibers are flexed to provide a contacting force between the angle ends and the elliptical detector elements.

16. The PLC assembly of claim 12, wherein the detector elements are arranged in a staggered configuration relative to one another.

17. The PLC assembly of claim 12, wherein the O/E receiver unit includes fiber guides disposed adjacent the detector elements and configured to maintain the receiver group of fibers in place relative to the corresponding detector elements.

18. The PLC assembly of claim 12, further including a boot member having an input end and an output end and disposed adjacent the guide member back end and adapted to transition the optical fibers from a non-planar geometry at the input end to a planar geometry at the output end.
